(19) United States
(12) Patent Application Publication
(10) Pub. No.: US 2020/0316413 A1
(43) Pub. Date: Oct. 8, 2020

(54) FACE MASK FILTER HOLDER

(71) Applicant: Respro (UK) Limited, London (GB)

(72) Inventor: Henry COLE, London (GB)

(21) Appl. No.: 16/906,798

(22) Filed: Jun. 19, 2020

Related U.S. Application Data
(63) Continuation of application No. PCT/GB2018/053744, filed on Dec. 21, 2018.

(30) Foreign Application Priority Data
Dec. 22, 2017 (GB) 1721829.8

(51) Int. Cl. A62B 18/02; A62B 23/02; A41D 13/11

(52) U.S. Cl. CPC A62B 18/025; A41D 13/1161; A41D 13/1138; A62B 23/025

(57) ABSTRACT

A face mask filter holder (2) for holding a filter (20) is provided, the filter holder (2) comprising a support structure and a perimeter part (8) configured to receive at least part of an edge of the filter. The support structure comprises a first part (4), positionable over a first nostril (7), and a second part (6), positionable over a second nostril (9). With the support structure in an open configuration, the filter is insertable in a recess between the first part (4) and the second part (6), and the edge of the filter is receivable by the perimeter part (8).

### CROSS-REFERENCE TO RELATED APPLICATIONS

This application is a continuation of International Application No. PCT/GB2018/053744, filed Dec. 21, 2018 which claims priority to UK Application No. GB 1721829.8, filed Dec. 22, 2017, under 35 U.S.C. § 119(a). Each of the above referenced patent applications is incorporated by reference in its entirety.

### BACKGROUND OF THE INVENTION

In urban areas filtration masks are regularly used to reduce the inhalation of harmful pollutants such as particulates from diesel emissions and others. It is of particular importance to filter pollutants from the air during exercise as the volume of gas inhaled per minute is greatly increased. However, filtration masks are known to restrict airflow during heavy breathing and can in such circumstances be more likely to allow inward leakage of unfiltered air.

It is desirable to increase the airflow to a wearer of a filtration mask while maintaining suitably low levels of inward leakage of unfiltered air.

### BRIEF DESCRIPTION OF THE DRAWINGS

FIG. 1 shows schematically a perspective view of a face mask filter holder in an open configuration.

FIG. 2 shows schematically another view of a face mask filter holder in an open configuration.

FIG. 3 shows schematically a side view of a face mask filter holder, with a filter received in a recess, in a closed configuration.

FIG. 4 shows schematically a cross section of a filter and a face mask filter holder, the filter received by a recess and the edge of the filter received by a perimeter part.

FIG. 5 shows schematically a cross section of a filter, a face mask filter holder, an outer structure, a first and a second fastener, with the filter received by the face mask filter holder and the face mask filter holder received by the outer structure.

FIG. 6 shows schematically a view of a face mask filter holder, a filter, a first fastener, and a second fastener positioned over a first and a second nostril.

FIG. 7 shows schematically another view of a face mask filter holder, a filter, a first fastener and a second fastener, with the filter received by the face mask filter holder and being in an open configuration.

FIG. 8 shows schematically a side view of a face mask filter holder.

FIG. 9 shows schematically a different side view of a face mask filter holder.

FIG. 10 shows schematically a rear view of a face mask filter holder in an open configuration.

### DETAILED DESCRIPTION OF CERTAIN INVENTIVE EMBODIMENTS

Examples are described herein of a face mask filter holder 2 for holding a filter 20, the filter holder comprising: a support structure comprising a first part 4 positionable over a first nostril 7 and a second part 6 positionable over a second nostril 9, and a perimeter part 8 configured to receive at least part of an edge of the filter, wherein with the support structure in an open configuration, the filter is insertable in a recess between the first part and the second part, and the edge of the filter is receivable by the perimeter part. By receiving the filter in the recess of the filter holder and with at least part of the edge of the filter received by the perimeter part, the support structure and the perimeter part at least partly hold the filter in an open configuration such that the filter is positionable over at least one of the first nostril or the second nostril of a wearer and can generally remain in that configuration during use, even when the wearer is heavily breathing during exercise.

The perimeter part of the filter holder can be considered to hold, or anchor, the edge of the filter in a given position and configuration, with the filter received by the recess between the first and second part. Thus, the perimeter part can provide a stable positioning of the edge of the filter and leverage to maintain the filter in the open configuration, for example when the filter is positioned over the first nostril or the second nostril of a wearer.

During inhalation through a first nostril and/or a second nostril, and in further examples a mouth 11 too, with a filter placed over the first and the second nostril, the filter can experience a force directed towards the first nostril and the second nostril. In known systems without the filter holder of examples described herein, and with the filter positioned over the first nostril or the second nostril, the pressure generated by inhalation through the first nostril or the second nostril can bias or pull the filter towards the first or second nostril. In doing so, the filter can bend inwards and increase contact with a user's face, in turn reducing the size of a cavity between the filter and the user's face 42, and in turn reducing the size of the airway through the filter by which the wearer inhales. This can restrict air inhalation by a wearer especially during heavy exercise. In contrast, in examples described herein, an inwards force on the filter generated by inhalation is counteracted by the mechanical support of the face mask filter holder which holds the filter away from contact with the first nostril or the second nostril.

In some examples the edge of the filter may refer to a part of the edge of a filter; it is not necessary in some examples that the entire edge of the filter is received by the perimeter part for the filter to be biased away from, or held away from, contact with the first nostril or the second nostril.

Biasing or holding the filter away from the first nostril or the second nostril can increase the size of a cavity between the nostrils and the filter. By increasing the average size of the cavity between the nostrils and the filter, the surface area through which inhaled air can be filtered is increased, meaning that more air can pass through the filter during inhalation. This is of particular importance in masks designed for vigorous activity where the rate of air intake is far greater than when resting. In examples given air may be ambient air or any breathable gas or gaseous mixture.

Moreover, face mask filters often become damp during use as the exhalations of the user or wearer contain significant amounts of water vapour and are prone to deformation after prolonged use and when wet. With the support provided by the filter holder holding the filter in the open configuration, the volume of the cavity between the first nostril and the second nostril and the filter can be increased compared with known face mask filters, and can thereby reduce the density of humidity therein. By biasing or holding the filter away from contact with at least one of the first nostril or the second nostril, the surface area of the filter through which air can be filtered is increased during inhalation as there is a reduction in any partial collapsing or inward deformation of the filter during inhalation. Examples will now be explained in more detail.

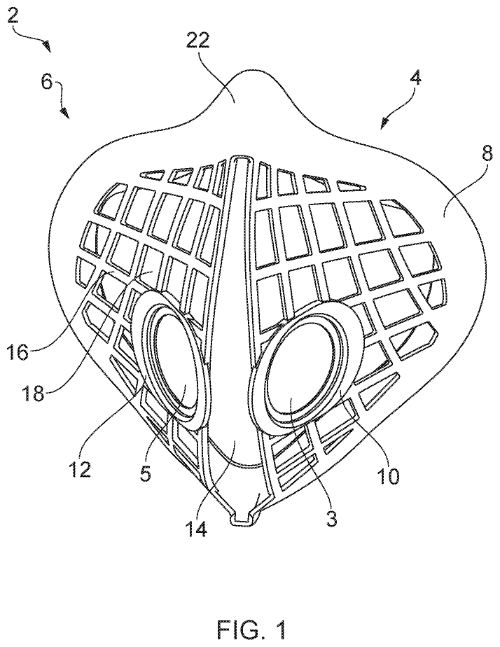

FIG. 1 shows schematically a face mask filter holder in an open configuration according to examples, which include a perimeter part and a support structure having a first part and a second part with the support structure in the open configuration. The first part and the second part may each be considered a side of the filter holder, and in some examples each of the first and second parts may be considered a wing, lobe or flap of the filter holder. The first part and the second part are in some examples symmetrically identical or generally identical in shape, but in other examples the first and second parts may have different shapes from each other when one is viewed as a mirror image. For example, the face mask filter holder can be customised in shape to a face 42 of a user where the face of the user is asymmetrical. For example, the first part and the second part may each be considered first half and a second half of the filter holder, with the first part at least partly connected to the second part along an axis of symmetry or other axis along which the filter holder may be folded. The first part may therefore be placed generally along or over one side of a nose and in some examples mouth of a user, and the second part may therefore be placed generally along or over the other side of the nose and in some examples mouth of a user.

The open configuration can be any configuration where there is a recess between the first part and the second part that is large enough to receive the filter. The open configuration may therefore correspond with a configuration used when positioning the filter holder over the nose of the user and when the filter holder is worn in use by a wearer.

The filter holder in examples such as this example has a support structure and a perimeter part. The perimeter part may be considered a region which includes a perimeter or periphery of the filter holder. Further details of the perimeter part are described further below. The support structure is for example a region of the filter holder different from the perimeter part, which acts to at least partly hold the filter in the open configuration, together with at least part of the edge of the filter held by the perimeter part. For example, the perimeter part may be manufactured separately from the support structure then fused, bonded or otherwise attached to the perimeter part. In other examples, the perimeter part may be considered to be a perimeter part of the support structure which includes an edge of the support structure.

A filter is for example a piece of fabric or other material cut with a shape to fit over a wearer's nostrils, at least part of their nose and in some examples their mouth. The fabric or other material has filtration properties for pollutants such as particulates in polluted air. For example, the fabric or material may have a suitably dense mesh or weave to trap particulates, and/or may include materials which absorb gas or trap particulates, such as activated charcoal. Although a filter can be rigid in structure, this can be restrictive as different users have different shaped faces. Hence, a filter is usually at least partly flexible so that it can be deformed to more closely accommodate the contours of a user's face. But, as explained above, the filter material or fabric may become more flexible and less self-supporting in shape when exposed to damp exhaled air and increased temperatures during use.

In examples such as this example, but not other examples, the first part comprises a first filter attachment part 10 for attachment to a first non-edge part of the filter. A non-edge part of the filter is for example an interior part of the filter away from an edge of the filter which is received by the perimeter part of the filter holder.

In examples, the support structure has a resilient shape providing a gap or cavity between the first nostril or the second nostril and the filter holder when positioned over the nose of a user, and by attaching the non-edge part of the filter to the first part of the support structure, the filter may be held or biased away from contact with the first or second nostril. The first filter attachment part may be configured such that when the first part is positioned over a first nostril the first filter attachment part is at a position on the first part furthest away from the first nostril. However, the first filter attachment part may be positioned anywhere on the first part such that when the non-edge part of the filter is attached to the first part of the support structure, the filter is biased away from the first nostril or the second nostril.

In some examples, the first filter attachment part comprises a first opening 3 through the first part, and the first opening is configured to receive a first fastener 30 for attachment to the first non-edge part of the filter. A fastener may be a toggle, a button, a clip, a buckle or any suitable means or structure or assembly for attaching the filter to the support structure. An opening may be referred to as a hole, a split, an aperture or any other suitable means for receiving a fastener. The first opening is substantially round in these examples. However, the shape of the first opening may be any shape configured to receive the first fastener in other examples. A non-edge part of the filter may be considered any part of the filter which is not receivable by the perimeter part. In other examples the first filter attachment part is configured for attachment to the first non-edge part of the filter by means such as Velcro™, press studs, or any other suitable attachment parts means such that when the first non-edge part of the filter is attached to the first filter attachment part the filter is biased away from contact with the first nostril or the second nostril. In some examples the first fastener comprises a first valve which facilitates the passage of gas from within the chamber or cavity between the first or second nostril and the filter. A valve may be any apparatus which allows the passage of fluid in one direction only.

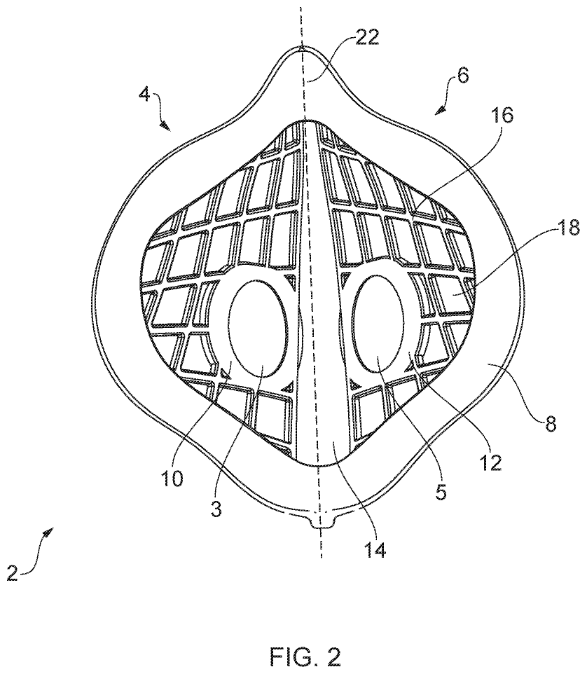

Referring to FIG. 2, the second part may comprise a second filter attachment part 12 configured for attachment to a second non-edge part of the filter. The second filter attachment part may be similar in form and function to the first filter attachment part. With the second non-edge part of the filter attached to the second filter attachment part, the filter is biased away from contact with the first or second nostril. The second filter attachment part is positioned to optimise the biasing away of the filter from the second nostril. The second filter attachment part is configured such that when the second part is positioned over the second nostril the second filter attachment part is at a position on the second part furthest away from the second nostril. However, the second filter attachment part may be positioned anywhere on the second part such that when the non-edge part of the filter is attached to the second part, the filter is biased away from the first nostril or the second nostril.

The second filter attachment part comprises in some examples a second opening 5 through the second part, the second opening configured to receive a second fastener 32 for attachment to the second non-edge part of the filter. The second opening is substantially round, where substantially indicates an acceptable variation from a perfect round shape, for example due to acceptable manufacturing tolerances. However, the shape of the second opening may be any shape configured to receive the second fastener. In other examples the second filter attachment part is configured for attachment to the second non-edge part of the filter by means such as Velcro™, press studs, or any other suitable attachment means. The second fastener may comprise a second valve which facilitates the passage of gas from within the chamber between the first or second nostril and the filter. In FIG. 2 the first attachment part and the second attachment part are a first opening positioned within the first part and a second opening positioned within an equivalent position on the second part respectively, where the first part of the support structure and the second part of the support structure are symmetrical in shape. However, the first attachment part and the second attachment part may be positioned in substantially inequivalent positions on their respective parts. Positioning the first attachment part and the second attachment part in substantially inequivalent positions may ensure e that the first attachment part is positioned at the furthest position on the first part from the first nostril and the second attachment part is positioned at the furthest position on the second part from the second nostril. In examples where the nostrils are not symmetrically positioned the first attachment part and the second attachment part may be not symmetrically positioned. Both the first attachment part and the second attachment part are openings configured to receive the first fastener and the second fastener respectively. In other examples the first attachment part is configured to attach to the first non-edge part of the filter by means such as Velcro, press studs, or any other suitable attachment means, and the second attachment part is configured to attach to the second non-edge part of the filter by any suitable means which may be similar or different from the first attachment part.

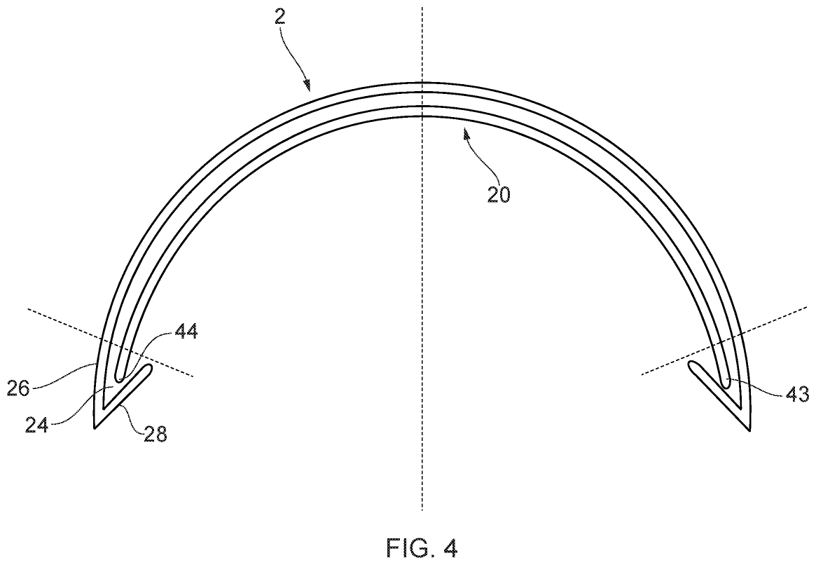

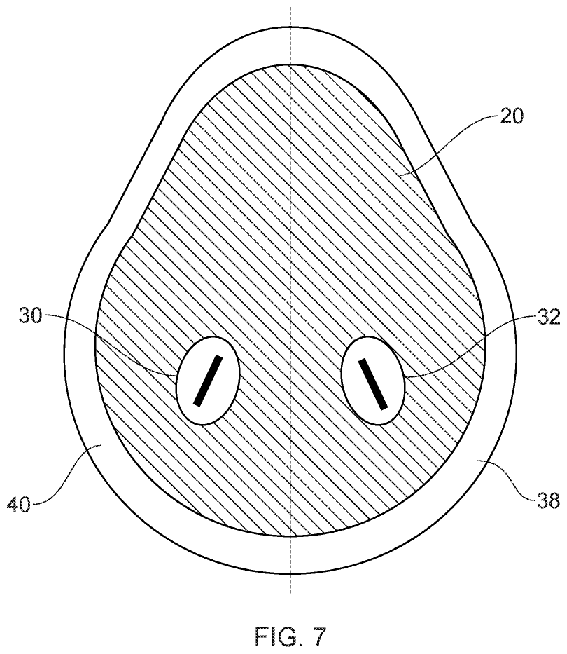

According to examples as in FIG. 7 the perimeter part has a first portion 40 associated with the first part of the support structure and a second portion 38 associated with the second part of the support structure. Thus, the first portion may be part of, or connected to, the first part of the support structure, and the second portion may be part of, or connected to, the second part of the support structure. The first portion is configured to receive a first edge part of the filter 44, where the first edge part of the filter is a part of the edge of the filter. The first portion of the perimeter part in examples comprises a first channel 24, for example a substantially V-shaped channel, in which the first edge part of the filter is received as seen in FIG. 4. A channel may be considered a groove, a slot, a notch or any other longitudinal opening or recess. A V-shaped channel is for example any channel that tapers towards the base of the channel. With the first edge part of the filter received by the first portion of the perimeter part and with the filter positioned over a first nostril or a second nostril, the negative pressure on the filter generated by inhalation through the first nostril or the second nostril forces the first edge part of the filter into the first substantially V-shaped channel of the first portion of the perimeter part. This means that during inhalation the filter is seated more tightly in the filter holder which can anchor the edge of the filter thereby preventing the filter from moving towards the first and second nostrils and from moving outwards across a facial area covered by the filter. In turn, the filter may remain in a more open configuration than if the edge of the filter can move more freely during inhalation and exhalation by a user. It is not necessary in other examples that the first portion of the perimeter part comprises a channel to receive the first edge part of the filter. The first edge part of the filter may be received by the first portion of the perimeter part by means of an adhesive surface, a press stud, or any other means suitable for holding the edge of the filter. In examples where the first part of the filter is received by the first portion of the perimeter part in a channel, the channel may not be substantially V-shaped; the base of the channel may be square, round, hexagonal, or any other shape in cross section suitable for receipt of the first edge part of the filter.

The second portion of the perimeter part is configured to receive a second edge part of the filter 43 where the second edge part of the filter is a part of the edge of the filter. The second portion of the perimeter part may be positioned at an opposing side of the perimeter part to the first portion or may be adjacent to the first portion of the perimeter part. The second portion of the perimeter part may comprise a second channel, for example a substantially V-shaped channel, in which the second edge part of the filter is received as seen in FIG. 4. With the second edge part of the filter received by the second portion of the perimeter part and with the filter positioned over a first nostril or a second nostril, the negative pressure on the filter generated by inhalation through the first nostril or the second nostril forces the second edge part of the filter into the second V-shaped channel of the second portion of the perimeter part, thus having a similar effect as the first perimeter part by holding the second edge part of the filter in position to in turn help to hold the filter in a more open configuration. The second edge part of the filter may be received by the second portion of the perimeter part by any means suitable for holding the second part of the filter. Where the second part is received by a channel the channel may be any shaped channel in cross section suitable for accepting the second part of the filter such as square, round, or hexagonal.

The perimeter part can be considered to provide leverage on the filter for increasing the volume of the chamber or cavity between the first or second nostril and the filter when the first edge part of the filter and the second edge part of the filter are parts of the edge of the filter. However, the first edge part of the filter may be any edge part of the filter receivable by the first portion of the perimeter part and the second edge part of the filter may be any part of the filter receivable by the second portion of the perimeter part.

A consideration when designing face mask filtration systems is the risk of inward leakage. Inward leakage is the passage of unfiltered air into a chamber between the filter and the user's nostrils. Unfiltered air is any gas which has not passed through the filter. It is desirable that all air which passes into such a chamber or cavity has passed through the filter. A chamber may also be a cavity. If unfiltered air is allowed to enter the chamber without passing through the filter the risk of harmful pollutants being inhaled by the user is greater. A pollutant is for example any particulate or gas which may cause damage to the user when inhaled.

Examples of the face mask filter holder where the means by which the perimeter part receives the edge of the filter in a channel, such as a V-shaped channel, can be particularly useful. Inward leakage is more likely to occur during inhalation than exhalation. With the filter received in the filter holder and positioned over the nostrils of the user, when the user inhales, negative pressure is created in the chamber between the user and the filter and this causes an influx of air either through the filter or around the filter. Where the edge of the filter is received in a channel such as the V-shaped channel the negative pressure on the filter generated by inhalation forces the edge of the filter towards the base and/or outer side 26 of the V-shaped channel, thereby suppressing the ability for air to pass around the filter in the V-shaped channel and into the chamber between the filter and the user. Due to the tapering of the channel at the base of a V-shaped channel, when a filter is forced into the base and/or side of the channel, the walls of the channel can press tighter into the filter edge. The more inward force on the filter the tighter the seal around the edge of the filter becomes.

In FIG. 2 there is shown schematically a face mask filter holder wherein the perimeter part is substantially continuous so as to receive substantially the entire edge of the filter. Continuous is for example an uninterrupted or unbroken channel, and substantially is for example more than 90%. Having a substantially continuous perimeter part may be beneficial by seating and providing an anchor point to substantially the entire edge of the filter. This provides more support to the filter which increases biasing away from the first nostril and the second nostril with the filter in position over the first nostril or the second nostril. There are also benefits related to inward leakage as a substantially continuous perimeter receiving the edge of the filter in a channel is able to reduce the amount of air passing around the filter as described above. However, in some examples the perimeter part may be discontinuous, separately receiving the first part of the filter and the second part of the filter in a separate first and second portion.

In some examples where the perimeter part receives the edge of the filter in a channel, a first side 26, such as an outer side, of the channel is connected to the support structure, such that the channel opening is directed towards the interior of the recess between the first part and the second part of the support structure. Here the first side of the channel refers to a first wall of the channel not a first surface of the channel. The connection of the support structure and the first side of the channel allows greater support to be provided to the filter as the movement or realignment of the perimeter part results in corresponding movement or realignment of the support structure and conversely the movement or realignment of the support structure results in the corresponding movement or realignment of the perimeter part. In this way the support structure and the perimeter part maintain relative positions to each other designed to increase the facilitation of biasing the filter away from the first or second nostril.

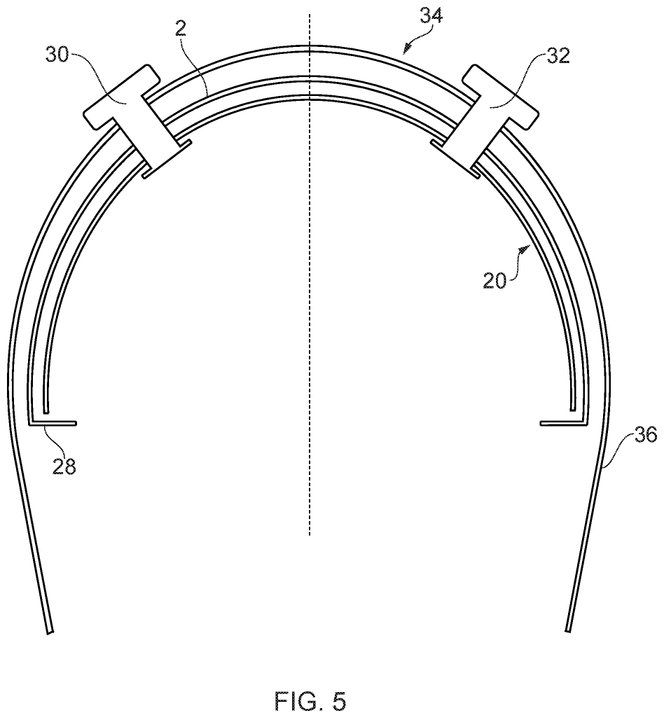

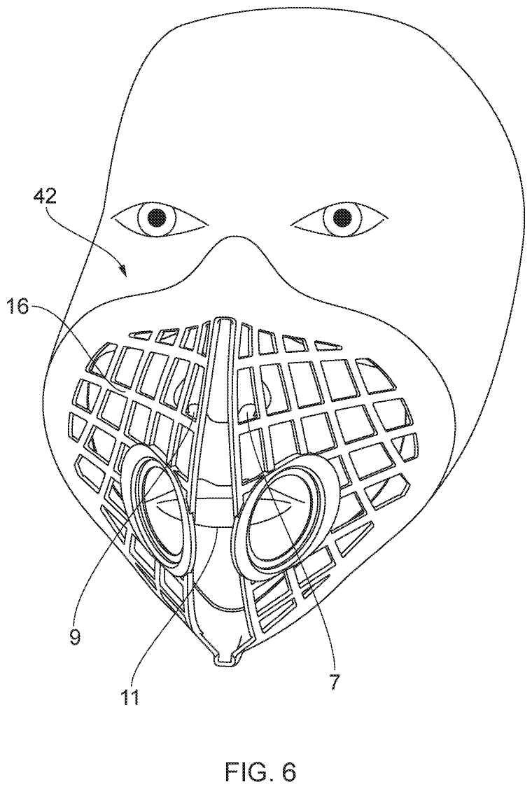

A second side of the channel 28, where the second side of the channel is for example an inner side such as a second wall of the channel not a surface, may be at least part of a seal for engagement with the skin of a user. To optimise filtration and reduce inward leakage of air into the breathing chamber, any gap between the edge of the filter and the user should be minimised and ideally non-existent. FIG. 5 shows schematically the edge of the filter being received in the channel of the perimeter part, where the perimeter part is substantially continuous, and the second side of the channel is engageable with the skin of the user in order to seal the breathing chamber away from the unfiltered air. With the filter received by the filter holder and positioned over the first nostril and second nostril, shown in FIG. 6, during inhalation through the first nostril or the second nostril the negative pressure in the chamber forces the edge of the filter deeper into the channel of the perimeter part and pushes the second side of the channel into contact with at least some of the skin of the user. Where the second side of the channel is pressed into the skin of the user, the second side of the channel seals a gap between the second side of the channel and the skin of the user. This seal blocks the air passing around the filter into the chamber thereby reducing the amount of air entering the breathing chamber without passing through the filter. This may be optimised in examples where the perimeter part is substantially continuous, closing any gaps between the second side of the channel and the user's skin results in air having to pass through the filter to enter the chamber. Where a seal is formed by the whole perimeter part only a relatively small amount of inhalation is needed to substantially press the perimeter part into the skin creating a tighter seal. However, in configurations where the perimeter part is not substantially continuous the ability of the second side of the channel to act as a seal with the skin of a user may still be beneficial in decreasing the amount of inward leakage. In examples where the first part of the filter or the second part of the filter is received by means other than a channel, there may be provided at least part of a seal on the perimeter part for engagement with the skin of the user.

Referring back to FIG. 5, in the open configuration the second side of the channel may be biased outwards and movable inwards, towards the first side, upon engagement with the skin of the user by means of appropriate flexibility. In this configuration the second side of the channel is biased outwards towards the skin of a user when the filter holder is positioned over the nose of the user. This improves the seal made between the second side of the channel and the skin of the user, which is important for reducing inward leakage. When the filter holder is placed over the nose of a user, the second side of the channel presses into the skin of the user and moves inward toward the first side of the channel by flexibly bending. In examples where the second side is more flexible the comfort provided to the user when the second side is in contact with a user's face is increased. The flexibility of the second side results in the second side substantially (for example sufficiently) maintaining contact with the skin of the user during use resulting in a better sealing between the second side of the channel and the skin of the user. In some examples a material of at least the second side is generally impermeable to moisture, such that when a user perspires this moisture forms a layer between the second side and the user's skin to help reduce inwards leakage of air. In other examples, the material of at least the second side may be at least partly absorbing to such moisture, to increase an adhesive property to a user's skin, again to help reduce inwards leakage.

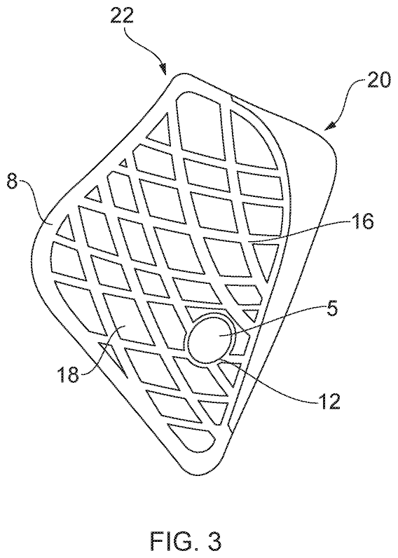

FIG. 3 shows schematically a side view of a face mask filter holder displaying an example of the support structure. This support structure comprises a plurality of openings 18 for passage of gas therethrough. With the filter held in a more open configuration, a larger filtration surface increases the amount of air which can pass from the outside of the filter into the chamber. It may be desirable to have as much air directly in contact with the surface of the filter as possible to increase transmission of air through the filter. Once air has passed through the filter it becomes filtered air, which is for example as any breathable gaseous matter which has passed through the filter. Where the filter is received by the recess in the support structure it is important to provide means for the filter to be in contact with the air. The plurality of openings is provided in the support structure such that with a filter positioned in the recess, and the filter holder positioned over the nose of the user, the air can pass through the openings to be filtered by the filter before entering the chamber. The plurality of openings can be sized and shaped differently to those shown in FIG. 3 and different sizes and shapes may have different benefits in terms of air flow, as the skilled person will appreciate.

The support structure shown in FIG. 2 comprises a framework 16 which defines the plurality of openings. A framework may be a matrix, a wire structure, struts, or anything which performs substantially the support function for the support structure described herein. With the filter positioned in the recess between the first part and the second part of the support structure and the filter and filter holder positioned over the first nostril and the second nostril, the framework braces the filter facilitating the biasing of the filter away from contact with the first nostril and the second nostril. To increase air flow through the filter the plurality of openings can be increased in number, average area or both. Unless other structural properties or dimensions of the filter holder are also changed, increasing the number or average area of the plurality of openings will reduce the support provided by the framework for biasing the filter away from the first nostril or the second nostril. In some examples it may be beneficial to increase airflow and allow a reduction in the amount of support provided by the framework and in other examples it may be useful to increase the support provided to the filter while allowing a decrease in airflow. Airflow is defined as the rate at which air enters or exits the chamber for a given surface area of the filter. In examples which include at least one of a first attachment part or a second attachment part, the framework may comprise the first attachment part and the second attachment part. The framework may be sufficiently strong to attach to at least one of the first non-edge part of the filter or the second non-edge part of the filter and provide the increased support to the filter to bias the filter away from contact with the first nostril or the second nostril.

The first part of the support structure and the second part of the support structure may be connected to each other by at least the perimeter part. In configurations where the perimeter part is substantially continuous the first part and the second part may be connected to a first portion and a second portion of the perimeter part respectively. With a substantially continuous perimeter part the first part of the support structure and the second part of the support structure are connected. By having the first part of the support structure connected to the second part of the support structure the filter holder can better facilitate the biasing away of the filter from the first nostril or the second nostril. In the open configuration with the filter received by the filter holder and the first part of the support structure and the second part of the support structure connected by the perimeter part, the points on the perimeter part between the first part of the support structure and the second part of the support structure can act as pivots or anchors for increasing the leverage provided by the perimeter part for facilitating the biasing of the filter away from the first nostril or the second nostril.

There may be a longitudinal opening 14 between an edge of the first part and an edge of the second part as seen in FIG. 2. The longitudinal opening is between the framework on the first part of the support structure and the framework on the second part of the support structure. The length of the longitudinal opening is taken across the support structure, between the two different points on the perimeter part. In some examples, the longitudinal opening between the first part and the second part is sufficiently wide to allow a front part of the filter to pass through it. With the filter received by the filter holder and the filter holder in the open configuration the front part of the filter may be positioned in the longitudinal opening. This can prevent the lateral movement of the filter within the filter holder, where lateral movement of the filter is movement of the filter across the width of the longitudinal opening. This may be beneficial in filtration mask filter holders used for rigorous activities as the increased motion can otherwise jostle and misalign the filter, resulting in the first attachment part or second attachment part being positioned in positions which are not intended to increase the biasing of the filter away from the first nostril or the second nostril. The longitudinal opening can also allow increased airflow through the filter as more of the filter is in contact with the air, but due to the anchoring of the filter in the longitudinal opening it does not lead to a decrease in the support of the filter which biases the filter away from contact with the first nostril or the second nostril.

In examples provided, the face mask filter holder is foldable along the longitudinal opening. Foldable is defined as the filter holder being movable from an open configuration to a closed configuration and in the reverse. The closed configuration may be a configuration where a majority of the first part of the support structure and a majority of the second part of the support structure are in contact such that there is no recess between the first and second parts. The closed configuration may be considered a configuration in which the filter cannot be inserted between the first part of the support structure or the second part of the support structure. With the filter received by the filter holder the closed configuration may be considered as a position in which the filter is collapsed or folded such that it cannot be positioned over the nose of the user. In some examples the filter holder is biased to the closed configuration such that when the filter is received by the filter holder and the filter holder is positioned over the first nostril and the second nostril the filter holder tends to close around the nose of the user. This has the benefit of biasing the perimeter part to contact the skin of the user, in examples where the perimeter part comprises a second channel comprising at least a part of a seal, or where the perimeter part comprises at least part of a seal, the biasing of the filter holder to the closed position causes the filter holder to engage more firmly with the skin of the user forming a tighter seal. The closed configuration can also provide the benefit that the face mask filter holder is smaller and more packable than in the open configuration, where packable is the ability to be stored inside a bag, a pocket or any other enclosed area.

In some examples, with the filter positioned over the first nostril and the second nostril of the user, the perimeter part may be in contact with the nose of the user. The perimeter part may comprise a nose engagement portion 22 shaped to engage with a bridge of the nose of the user. The nose engagement portion may be shaped to engage the bridge of the nose of the user by being biased to a closed configuration at the nose engagement portion. By engaging with the bridge of the nose of the user the perimeter part can more securely hold the filter over the first nostril and the second nostril of the user. This can aid users performing rigorous activity as otherwise the filter is more likely to move away from a position designed to increase the volume of the chamber. An outer portion of the nose engagement part may be shaped to receive a bridge of the user's spectacles. The nose engagement part may have a ridge to support the bridge of a user's spectacles. By positioning the spectacles of the user on an outer portion of the filter holder, and with the perimeter part being at least part of a seal for engagement with the skin of the user, for example with the V-shaped channel described earlier, during exhalation the humid gaseous mixture coming from the user is directed away from the user's spectacles. This reduces the fogging of the user's spectacles when a filter is placed over the first nostril or the second nostril.

In some examples the filter holder is suitable for positioning over the first nostril, the second nostril, and a mouth of the user, with the perimeter part in contact with a perimeter of a facial area enclosing the first nostril, the second nostril, and the mouth. By enclosing both nostrils and the mouth of the user it is possible to greatly reduce the volume of unfiltered air which is inhaled when compared to systems which filter only air inhaled through the mouth or the nostrils. Increasing the facial area which is covered by the filter and the filter holder while maintaining a substantially similar profile has the effect of increasing the volume of the breathing chamber. This allows lower humidity in the chamber, greater airflow to the user, and increased comfort for the user. Where the filter holder is suitable for positioning over the nostrils and the nose, the perimeter part may be engageable with the bridge of the nose, the chin, and both cheeks of the user.

The material of the support structure of the face mask filter holder may be a polymer material, for example a thermoplastic elastomer which provides suitable flexibility and resilience such that the face mask filter holder can be flexibly bent and may return to its shape when tension is removed. This may be useful where the face mask filter holder should conform to and be engaged with the user's face. It allows the face mask filter holder to be used by a variety of different face shapes. The resilience and flexibility of the face mask filter holder also gives support to the filter when the filter is received by the face mask filter holder as described previously. In some examples the second side of the channel of the perimeter part comprises a different material to the support structure. This material may be more flexible than that of the support structure to allow for the second side of the channel to be used as at least part of a seal for engagement with the skin of the user.

In some examples there is a face mask comprising the filter holder as described above and a filter, the filter being suitable for receipt by the filter holder and for positioning over a first nostril and a second nostril. An edge of the filter may be substantially (within functionally acceptable tolerances) the same length as the perimeter part of the filter holder. An area of the filter may be substantially similar (within functionally acceptable tolerances) to the area of the filter holder. The filter may have a first filter opening through the first non-edge part of the filter configured to receive the first fastener for attachment to the first filter attachment part. The first filter opening may be substantially round. However, the shape of the first filter opening may be any shape configured to receive the first fastener. The filter may have a second filter opening through the second non-edge part of the filter configured to receive the second fastener for attachment to the second filter attachment part. The second filter opening may be substantially round. However, the shape of the second filter opening may be any shape configured to receive the second fastener. The first non-edge part of the filter and the second non-edge part of the filter may comprise other means for attachment to the first filter attachment part and the second filter attachment part respectively such as Velcro™, press studs, or any other means suitable for attachment.

In some examples, there is provided an outer structure 34 to cover the face mask filter holder. The outer structure may provide protection to the filter and the filter holder from the external environment. A majority of the outer structure may be neoprene, polyester, or any other suitable material. The outer structure may comprise at least one strap 36 for attaching the face mask to the user, for example around the back of their neck. With the filter received by the face mask filter holder the face mask filter holder may be received by the outer structure. The outer structure may comprise a first outer attachment part for attaching the first part of the support structure and the first non-edge part of the filter to the outer structure. The outer layer may comprise a second outer attachment part for attaching the second part of the support structure and the second non-edge part of the filter to the outer structure. The first outer attachment part and the second outer attachment part may attach to the filter and the filter holder by means of the first fastener and the second fastener respectively. In other examples the outer structure may comprise any means suitable for attaching to the filter and the filter holder.

The at least one strap of the outer structure may be a strap having fastening means such as Velcro™, a clip, a buckle, a button, or any other means suitable for securing the face mask filter holder over the first nostril or the second nostril of the user.

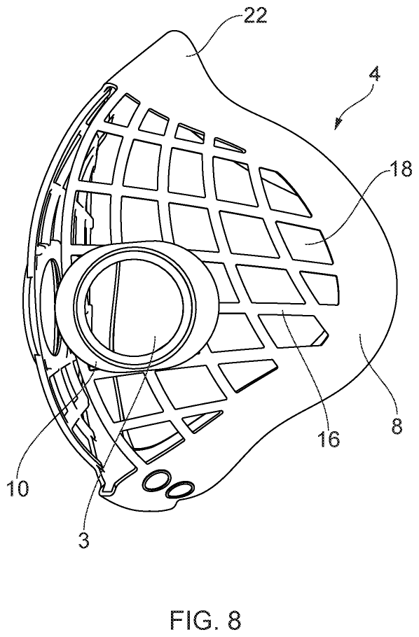

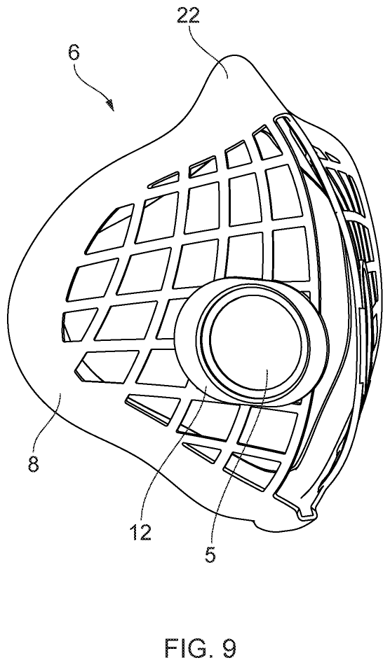

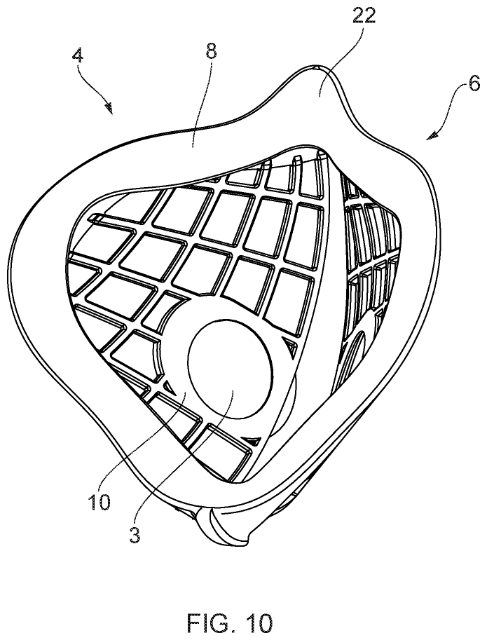

FIGS. 8, 9, and 10 illustrate further views of examples described above and are labelled accordingly.

The above examples are to be understood as illustrative examples. Further examples are envisaged. It is to be understood that any feature described in relation to any one example may be used alone, or in combination with other features described and may also be used in combination with one or more features of any other of the examples, or any combination of any other of the examples. Furthermore, equivalents and modifications not described above may also be employed without departing from the scope of the accompanying claims.

What is claimed is:

1. A face mask filter holder for holding a filter, the filter holder comprising:
a support structure comprising:
a first part positionable over a first nostril, and
a second part positionable over a second nostril; and
a perimeter part configured to receive at least part of an edge of the filter,
wherein with the support structure in an open configuration, the filter is insertable in a recess between the first part and the second part, and the edge of the filter is receivable by the perimeter part.

2. The face mask filter holder of claim 1, wherein with the support structure in the open configuration, the filter received in the recess, and the edge of the filter received by the perimeter part, the perimeter part is configured to at least partly hold the filter in an open configuration such that the filter is positionable over at least one of the first nostril or the second nostril.

3. The face mask filter holder of claim 1, wherein the first part comprises a first filter attachment part for attachment to a first non-edge part of the filter.

4. The face mask filter holder of claim 3, wherein the first filter attachment part comprises a first opening through the first part, the first opening configured to receive a first fastener for attachment to the first non-edge part of the filter.

5. The face mask filter holder of claim 3, wherein the first filter attachment part is configured for attachment to the first non-edge filter part of the filter.

6. The face mask filter holder of claim 1, wherein the second part comprises a second filter attachment part configured for attachment to a second non-edge part of the filter.

7. The face mask filter holder of claim 6, wherein the second filter attachment part comprises a second opening through the second part, the second opening configured to receive a second fastener for attachment to the second non-edge part of the filter.

8. The face mask filter holder of claim 6, wherein the second filter attachment part is configured for attachment to the second non-edge filter part of the filter.

9. The face mask filter holder of claim 1, wherein the perimeter part comprises:
a first portion of the perimeter part associated with the first part of the support structure, the first portion configured to receive a first part of the filter; and
a second portion of the perimeter part associated with the second part of the support structure, the second portion configured to receive a second part of the filter.

10. The face mask filter holder of claim 1, wherein the perimeter part is substantially continuous so as to receive substantially the entire edge of the filter.

11. The face mask filter holder of claim 1, wherein the perimeter part comprises a channel for receipt of the edge of the filter.

12. The face mask filter holder of claim 11, wherein a first side of the channel is connected to the support structure and a second side of the channel is at least part of a seal for engagement with the skin of the user.

13. The face mask filter holder of claim 12, wherein at least one of:
the second side of the channel is flexible and, with the support structure in the open configuration, the second side of the channel is biased outwards and movable inwards, towards the first side, upon engagement with the skin of the user; or
the second side comprises a material suitable for forming at least part of the seal for engagement with the skin of the user.

14. The face mask filter holder of claim 11, wherein the channel has a substantially V-shaped cross section.

15. The face mask filter holder of claim 1, wherein the support structure comprises at least one of:
a plurality of openings for passage of gas therethrough; or
a framework defining a plurality of openings for passage of gas therethrough.

16. The face mask filter holder of claim 1, wherein at least one of:
the first part is connected to the second part at least by the perimeter part;
the face mask filter holder comprises a longitudinal opening between an edge of the first part and an edge of the second part; or
the face mask filter hold comprises a longitudinal opening between an edge of the first part and an edge of the second part, wherein the support structure is foldable along the longitudinal opening between a closed configuration and the open configuration.

17. The face mask filter holder of claim 1, wherein the perimeter part comprises a nose engagement portion shaped to engage with the bridge of a nose of the user, an outer part of the nose engagement portion shaped to receive the bridge of the user's spectacles.

18. A face mask comprising:
a face mask filter holder for holding a filter, the filter holder comprising:
a support structure comprising:
a first part positionable over a first nostril, and
a second part positionable over a second nostril; and
a perimeter part configured to receive at least part of an edge of the filter,
wherein with the support structure in an open configuration, the filter is insertable in a recess between the first part and the second part, and the edge of the filter is receivable by the perimeter part; and
a filter.

19. The face mask of claim 18, comprising:
an outer structure configured to cover the face mask filter holder, the outer structure comprising at least one strap for attaching the face mask to the user.

20. The face mask of claim 19, wherein the filter is attached to the outer structure by at least one fastener fastened through the support structure.
